(19) United States
(12) Patent Application Publication
(10) Pub. No.: US 2013/0148066 A1
(43) Pub. Date: Jun. 13, 2013

(54) LIQUID CRYSTAL PANEL AND LIQUID CRYSTAL DISPLAY DEVICE

(71) Applicants: Yosuke Iwata, Osaka-shi (JP); Mitsuhiro Murata, Osaka-shi (JP); Yasuhiro Nasu, Osaka-shi (JP); Toshihiro Matsumoto, Osaka-shi (JP)

(72) Inventors: Yosuke Iwata, Osaka-shi (JP); Mitsuhiro Murata, Osaka-shi (JP); Yasuhiro Nasu, Osaka-shi (JP); Toshihiro Matsumoto, Osaka-shi (JP)

(73) Assignee: SHARP KABUSHIKI KAISHA, Osaka-shi, Osaka (JP)

(21) Appl. No.: 13/811,026

(22) PCT Filed: Jul. 15, 2011
(86) PCT No.: PCT/JP2011/066225

§ 371 Date: Feb. 21, 2013

(30) Foreign Application Priority Data
Jul. 22, 2010 (JP) 2010-165181

(51) Int. Cl. G02F 1/1337

(52) U.S. Cl. CPC G02F 1/1337
USPC 349/130

(57) ABSTRACT

A liquid crystal panel (2) comprises a liquid crystal layer (30) sandwiched between two substrates (10 and 20) and alignment films (15 and 22) in contact with a liquid crystal layer. The liquid crystal panel (2) is of a vertical alignment type which drives the liquid crystal layer (30) by a transverse electric field which is generated between an upper electrode (14) and an lower layer electrode (12). A polar anchoring strength of each of the alignment films (15 and 22) falls within a range from more than 5×10⁻⁶ J/m² to not more than 1×10⁻⁴ J/m².

### TECHNICAL FIELD

The present invention relates to a liquid crystal panel and a liquid crystal display device. More specifically, the present invention relates to (i) a liquid crystal panel which has a vertical alignment liquid crystal cell in which liquid crystal molecules are aligned perpendicularly to a substrate while no voltage is being applied and which is configured such that light transmission is controlled by applying a transverse electric field to the vertical alignment liquid crystal cell and (ii) a liquid crystal display device including the liquid crystal panel.

### BACKGROUND ART

Liquid crystal display devices are advantageous over various display devices in that they are thin, are light-weight, and consume less electric power. Therefore, in recent years, the liquid crystal display devices are widely used in various fields such as TVs (televisions), monitors, and mobile devices such as mobile phones, in place of CRTs (cathode ray tubes).

A display mode of a liquid crystal display device is determined by how liquid crystal molecules are aligned in a liquid crystal cell.

For example, an MVA (Multi-domain Vertical Alignment) mode has been conventionally known as a display mode of a liquid crystal display device. The MVA mode is as follows. Slits are formed in pixel electrodes of an active matrix substrate and projections (ribs) for controlling alignment of liquid crystal molecules are formed on a counter electrode of a counter substrate. This causes a vertical electric field to be applied. While the vertical electric filed is being applied, the liquid crystal molecules are controlled by the ribs and the slits so as to be oriented in multiple directions.

An MVA mode liquid crystal display device realizes a wide viewing angle by allowing liquid crystal molecules to be tilted in multiple directions when an electric field is applied. Moreover, since the MVA mode is a vertical alignment mode, it is possible to achieve a high contrast as compared to a liquid crystal display device employing a horizontal alignment mode such as an IPS (In-Plain Switching) mode (see Patent Literature 1 for example). However, the liquid crystal display device employing the MVA mode has a problem in that its production process is complicated.

Under such circumstances, in order to solve such a problem of a process of producing the MVA mode, there has been proposed a display mode in which a comb electrode is employed in a vertical alignment liquid crystal cell (vertical alignment cell) where liquid crystal molecules are aligned perpendicularly to a substrate while no voltage is being applied. The comb electrode causes an electric field parallel to a surface of the substrate (so called a transverse electric field) to be applied.

According to such a display mode, directions in which liquid crystal molecules are oriented are determined by driving the liquid crystal molecules by a transverse electric field while keeping a high contrast resulting from vertical alignment. Unlike the MVA, this display mode does not necessitate the control of alignment by use of projections. Therefore, a liquid crystal display device employing this display mode has a simple pixel structure and an excellent wide viewing angle.

The following description discusses, with reference to FIGS. 6 and 7, a typical configuration of a liquid crystal panel which employs the foregoing display mode, in which a transverse electric field is applied to a vertical alignment liquid crystal cell.

FIG. 6 is a view schematically showing a director distribution of liquid crystal molecules in a liquid crystal cell, observed in a case where the foregoing display mode in which a transverse electric field is applied to the vertical alignment liquid crystal cell is employed. FIG. 7 is a view showing an example of what voltage is applied to a comb electrode in the liquid crystal cell. Note that, in the example of FIG. 7, a voltage of 5 V is applied to each of adjacent comb electrodes.

As shown in FIG. 6, a liquid crystal panel 101 employing the foregoing display mode is configured such that, on a substrate 110 which is one of a pair of substrates 110 and 120 facing each other via a liquid crystal layer 130, a pair of comb electrodes 112 and 113 are provided so as to interdigitate each other. The pair of comb electrodes 112 and 113 serve as a pixel electrode and a common electrode.

Such a liquid crystal panel 101 is typically configured as follows. On one glass substrate (a glass substrate 111), a pair of comb electrodes 112 and 113 is provided and a vertical alignment film serving as an alignment film 114 is provided so as to cover the pair of comb electrodes 112 and 113. On the other glass substrate (a glass substrate 121), a vertical alignment film serving as an alignment film 122 is provided.

According to such a liquid crystal panel 101, by applying a transverse electric field between the pair of comb electrodes 112 and 113, a director distribution of liquid crystal molecules 131 is made symmetric with respect to the central part of an electrode line of each of the comb electrodes, and the liquid crystal molecules 131 form an arc-shaped (bend form) liquid crystal alignment distribution in a liquid crystal cell 105 (see FIG. 6). Therefore, the liquid crystal molecules 131 are (i) aligned vertically when power is OFF as described earlier and (ii) oriented so that self directors on both sides of the central part of the electrode line offset-compensate for each other when power is ON (see FIG. 7).

Therefore, the foregoing display mode makes it possible to realize (i) a high-speed response attributed to the bend orientation, (ii) a wide alignment of the self directors, and (iii) a high contrast attributed to a vertical alignment of liquid crystal molecules.

### CITATION LIST

### Patent Literatures

Patent Literature 1

Japanese Patent Application Publication, Tokukai No. 2001-318381 A (Published on Nov. 16, 2001)

Patent Literature 2

Japanese translation of PCT international publication, Tokuhyo No. 2010-519587A (Published on Jun. 3, 2010)

Patent Literature 3

Japanese Patent Application Publication,

Tokukai No. 2009-271390 A (Published on Nov. 19, 2009)

Patent Literature 4

Japanese translation of PCT international publication, Tokuhyo No. 2009-520702 A (Published on May 28, 2009)

### SUMMARY OF INVENTION

### Technical Problem

The foregoing display mode, however, has a problem in which a high drive voltage is required.

With regard to the problem, Patent Literature 2 discloses reducing a drive voltage by use of a combination of a vertical alignment film and FFS (Fringe Field Switching) drive.

In other words, Patent Literature 2 discloses reducing a drive voltage required in a vertical alignment liquid crystal display device which carries out a display by applying a transverse electric field, in the following manner. That is, the drive voltage required is reduced by reducing a threshold voltage which is for transmitting switching of a liquid crystal bulk, by employing an electrode having an FFS structure so that a fringe electric field is generated and thereby a liquid crystal is driven.

However, the liquid crystal display device having such a structure has the following problem. That is, an electric field is generated only between electrodes provided on one substrate. Therefore, liquid crystal molecules on the other substrate where the electric field is weak or liquid crystal molecules around the center of a space between adjacent electrodes are difficult to respond. This results in low transmittance.

The present invention has been made in view of the above problem, and an object of the present invention is to provide a liquid crystal panel and a liquid crystal display device each of which (i) employs a display mode in which a transverse electric field is applied to a vertical alignment cell and (ii) achieves a transmittance higher than those of conventional techniques.

### Solution to Problem

In order to attain the above object, a liquid crystal panel according to the present invention is a liquid crystal panel of a vertical alignment type, including: a first substrate on which (i) a lower layer electrode constituted by an allover electrode and (ii) an upper layer electrode constituted by a comb electrode are provided so as to overlap each other via an insulating layer; a second substrate which faces the first substrate; a liquid crystal layer sandwiched between the first substrate and the second substrate; and a first alignment film provided on the first substrate so as to be in contact with the liquid crystal layer and a second alignment film provided on the second substrate so as to be in contact with the liquid crystal layer, the first and the second alignment films causing liquid crystal molecules in the liquid crystal layer to be aligned perpendicularly to the first and second substrates while no electric field is applied, the liquid crystal layer being driven by a transverse electric field which is generated between the lower layer electrode and the upper layer electrode provided on the first substrate, and the first and second vertical alignment films each having a polar anchoring energy falling within a range from more than 5×10⁻⁶ J/m² to not more than 1×10⁻⁴ J/m².

Further, a liquid crystal display device according to the present invention includes a liquid crystal panel according to the present invention.

Polar anchoring energy of a general polyimide-type organic alignment film is 5×10⁻⁴ J/m².

Note however that, in a case where a liquid crystal panel has the above configuration, if the polar anchoring energy of a vertical alignment film is 5×10⁻⁴ J/m², the liquid crystal molecules in the liquid crystal layer at surfaces (interfaces) of the liquid crystal layer which surfaces are in contact with the vertical alignment films do not rotate even if a voltage of 5 V is applied to the liquid crystal panel.

However, the inventors of the present invention have conducted a study, and found the following. The liquid crystal molecules at the interfaces start to rotate when the polar anchoring energy of the vertical alignment film is reduced to 1×10⁻⁴ J/m², which is 50% of the polar anchoring energy of the general polyimide-type organic alignment film. With this, the liquid crystal panel requires less voltage and achieves higher transmittance as compared to a case where the aforementioned general polyimide-type organic alignment film is used (i.e. a case where the liquid crystal molecules at the interfaces do not rotate).

Further, the study by the inventors of the present invention also revealed the following. As described above, as the polar anchoring energy becomes smaller, the liquid crystal panel requires less voltage and achieves higher transmittance. However, when the polar anchoring energy is less than or equal to 5×10⁻⁶ J/m², i.e., 1% of the polar anchoring energy of the general polyimide-type organic alignment film, vertical alignment of liquid crystal molecules cannot be realized because liquid crystal molecules in the liquid crystal layer at surfaces (interfaces) of the liquid crystal layer which surfaces are in contact with the alignment films are anchored too weakly.

Therefore, it is preferable that the polar anchoring energy is set as weak as possible within a range from more than 5×10⁻⁶ J/m² to not more than 1×10⁻⁴ J/m².

### Advantageous Effects of Invention

As has been described, a liquid crystal panel and a liquid crystal display device according to the present invention is capable of not only reducing a voltage that it requires but also achieving high transmittance, by setting polar anchoring strength of each of the first and second vertical alignment films like above. This makes it possible to provide a liquid crystal panel and a liquid crystal display device each of which has a higher transmittance and better display quality than those of a conventional liquid crystal panel and a conventional liquid crystal display device.

### BRIEF DESCRIPTION OF DRAWINGS

FIG. 1 is a cross sectional view schematically showing (i) a configuration of a liquid crystal cell in a liquid crystal panel according to one embodiment of the present invention and (ii) a director distribution of liquid crystal molecules observed when a transverse electric field is applied.

FIG. 2 is an exploded sectional view schematically showing a configuration of a liquid crystal display device according to one embodiment of the present invention.

FIG. 3 is a view showing an example of what voltages are applied to an upper layer electrode and a lower layer electrode of the liquid crystal cell shown in FIG. 1.

(a) of FIG. 4 is a view showing transmittance, a director distribution of liquid crystal molecules, and an equipotential line, which are observed when a voltage of 2 V is applied to an upper layer electrode in Comparative Example 1. (b) of FIG. 4 is a view showing transmittance, a director distribution of liquid crystal molecules, and an equipotential line, which are observed when a voltage of 5 V is applied to an upper layer electrode in Comparative Example -b 1.

(a) of FIG. 5 is a view showing transmittance, a director distribution of liquid crystal molecules, and an equipotential line, which are observed when a voltage of 2 V is applied to an upper layer electrode in Example 3. (b) of FIG. 5 is a view showing transmittance, a director distribution of liquid crystal molecules, and an equipotential line, which are observed when a voltage of 5 V is applied to an upper layer electrode in Example 3.

FIG. 6 is a view schematically showing a director distribution of liquid crystal molecules in a conventional vertical alignment liquid crystal cell, which director distribution is observed when a display mode in which a transverse electric field is applied to the cell is employed.

FIG. 7 is a view showing an example of what voltage is applied to a comb electrode in the liquid crystal cell shown in FIG. 6.

### DESCRIPTION OF EMBODIMENTS

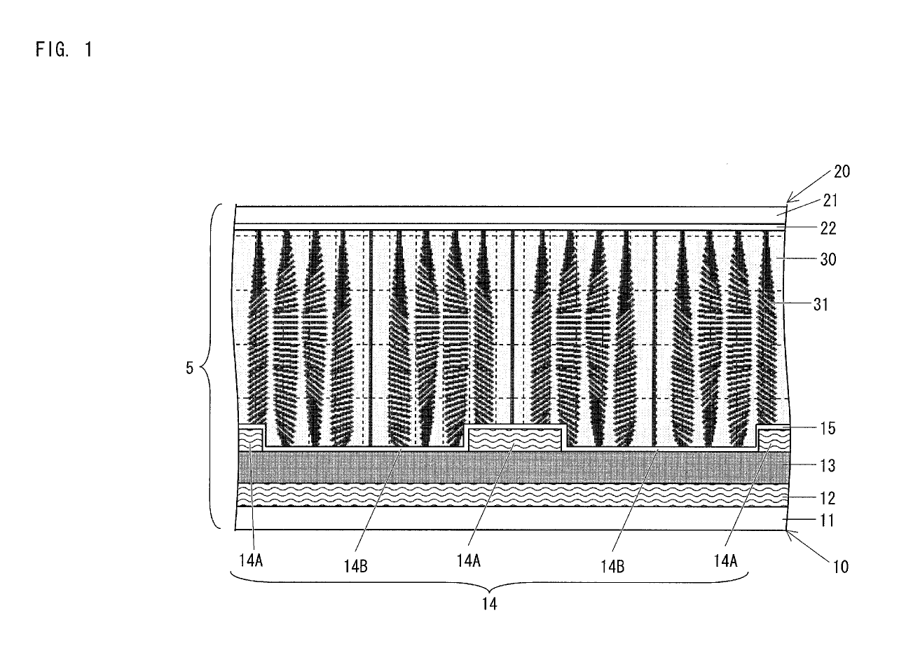

The following description discusses one embodiment of the present invention with reference to FIG. 1 to (a) and (b) of FIG. 5.

Note, however, that size, material, and shape of each constituent as well as their relative positions etc. described in the present embodiment merely constitute one embodiment, and thus the scope of the present invention should not be narrowly interpreted within the limits of such constituents.

First, the following description discusses a schematic configuration of a liquid crystal display device according to the present embodiment.

<Schematic Configuration of Liquid Crystal Display Device>

First, an overall configuration of a liquid crystal display device according to the present embodiment is schematically described.

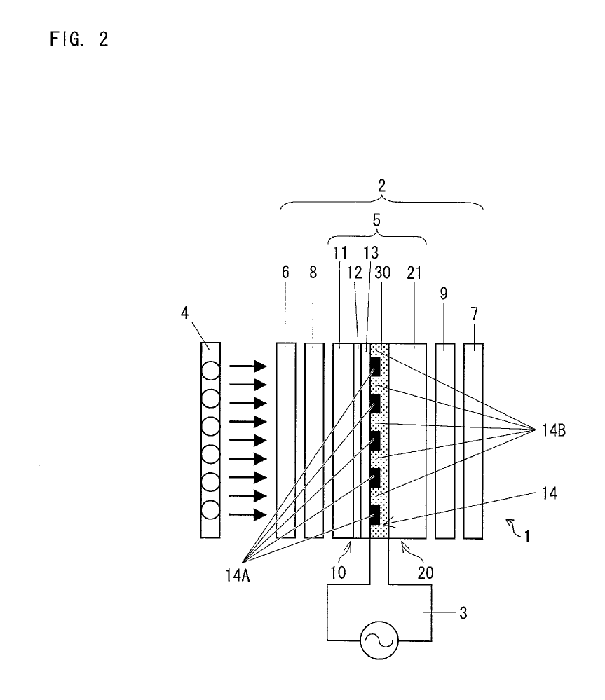

FIG. 2 is an exploded sectional view schematically showing a configuration of the liquid crystal display device according to the present embodiment. Note that part of the configuration is not illustrated in FIG. 2.

A liquid crystal display device 1 according to the present embodiment includes, as shown in FIG. 2, a liquid crystal panel 2 (liquid crystal display panel, liquid crystal display element), a drive circuit 3 which drives the liquid crystal panel 2, and a backlight 4 (illumination device) which is provided on the backside of the liquid crystal panel 2 and backlights the liquid crystal panel 2.

Since the configurations of the drive circuit 3 and the backlight 4 are the same as those of conventional techniques, their descriptions are omitted here. <Schematic Configuration of Liquid Crystal Panel 2>

Next, an overall configuration of the liquid crystal panel 2 is schematically described.

As shown in FIG. 2, the liquid crystal panel 2 includes a liquid crystal cell 5, polarizing plates 6 and 7, and if necessary, phase plates 8 and 9. The liquid crystal panel 2 is obtained by attaching the polarizing plates 6 and 7 and the phase plates 8 and 9 (if necessary) to the liquid crystal cell 5.

The polarizing plates 6 and 7 are provided on surfaces of respective substrates 10 and 20, which surfaces are opposite to surfaces that face a liquid crystal layer 30. Furthermore, if necessary, the phase plates 8 and 9 are provided for example (i) between the substrate 10 and the polarizing plate 6 and (ii) between the substrate 20 and the polarizing plate 7, respectively (see FIG. 2). The phase plates 8 and 9 may be provided only on one surface of the liquid crystal panel 2. The phase plates 8 and 9 are not essential in a case where a display device only uses light transmitted from a front direction.

The polarizing plates 6 and 7 are arranged for example such that their respective transmission axes are (i) perpendicular to each other and (ii) at an angle of 45 degrees to a direction along which each electrode part 14A (branch electrode) of an upper layer electrode 14 (shown in FIG. 1) extends.

<Schematic Configuration of Liquid Crystal Cell 5>

FIG. 1 is a cross sectional view schematically showing (i) a main part of the liquid crystal cell 5 and (ii) a director distribution of liquid crystal molecules observed when a transverse electric field is applied.

As shown in FIG. 1, the liquid crystal cell 5 includes a pair of substrates 10 and 20, which are arranged so as to face each other and serve as an array substrate (electrode substrate) and a counter substrate, respectively. A liquid crystal layer 30 serving as a medium layer for a display is sandwiched between the substrates 10 and 20.

The liquid crystal panel 2 is a vertical alignment liquid crystal panel which is driven by a transverse electric field. On a surface of the substrate 10 which surface faces the substrate 20 and on a surface of the substrate 20 which surface faces the substrate 10, respective alignment films and 22 (so-called vertical alignment films) are provided. The alignment films 15 and 22 cause liquid crystal molecules 31 in the liquid crystal layer 30 to be aligned perpendicularly to the surfaces of the substrates while no electric field is applied. The “perpendicularly” includes “substantially perpendicularly”.

Further, at least one of the substrates 10 and 20, that is, at least a substrate on a viewer's side, is provided with a transparent substrate such as a glass substrate serving as an insulating substrate (liquid crystal layer-holding member, base substrate). In the following description, the present embodiment discusses an example in which glass substrates are employed as insulating substrates. Note, however, that the present embodiment is not limited to this.

Further, in the following description, a substrate on a display surface side (viewer's side) is referred to as an upper substrate, and the other substrate is referred to as a lower substrate. Furthermore, in an example discussed in the following description, an array substrate is used as the lower substrate 10 and a counter substrate is used as the upper substrate 20. Note, however, that the present embodiment is not limited to this.

Next, each constituent of the liquid crystal cell 5 is discussed.

<Substrate 10>

As described above, the substrate 10 (first substrate) is an array substrate. The substrate 10 is for example a TFT substrate which is provided with TFTs (thin film transistors) serving as switching elements (not illustrated).

The substrate 10 is constituted by for example the glass substrate 11 on which a lower layer electrode 12 (first electrode), an insulating layer 13 (array side insulating layer), an upper layer electrode 14 (second electrode), and an alignment film 15 are stacked in this order.

The lower layer electrode 12 and the upper layer electrode 14 are electrodes for generating a transverse electric field. The lower layer electrode 12 and the upper layer electrode 14 are arranged so as to overlap each other via the insulating layer 13.

The lower layer electrode 12 is an allover electrode, and is provided on the almost entire surface of the glass substrate 11 which surface faces the substrate 20. The lower layer electrode 12 covers a display region (a region enclosed by a sealing material (not illustrated) for bonding the substrates 10 and 20 together) of the substrate 10.

The insulating layer 13 is provided all over the entire display region of the substrate 10 so as to cover the lower layer electrode 12.

The upper layer electrode 14 is a comb electrode which has patterned electrode parts 14A (electrode lines) and spaces 14B (parts where there is no electrode). More specifically, the upper layer electrode 14 is constituted by (i) a trunk electrode (trunk line) and (ii) branch electrodes (branch lines) which correspond to teeth of the comb, each of which branch electrodes extends from the trunk electrode. A cross section of the electrode 14A illustrated in FIG. 1 is a cross section of the branch electrodes.

The number (m, n) of the teeth (branch electrodes constituting the electrode parts 14A) of the upper layer electrode 14 which are provided in one pixel is not limited, and depends on for example a relationship between a pixel pitch and L/S etc. Note here that the L denotes electrode width of a branch electrode constituting an electrode part 14A, whereas the S denotes width of a space 14B, i.e., an electrode spacing between adjacent branch electrodes.

Each of the branch electrodes which constitute the branch parts 14A may be linear, in a V-shape, or in a zig-zag form.

The alignment film 15 is, as described earlier, a so-called vertical alignment film which causes liquid crystal molecules in a liquid crystal layer to be aligned perpendicularly to a surface of a substrate while no electric field is applied. The alignment film 15 is provided on the insulating layer 13 so as to cover the upper layer electrode 14.

<Substrate 20>

A substrate 20 (second substrate) is a counter substrate. The substrate 20 is, as shown in FIG. 1, constituted by for example a glass substrate 21 on which an alignment film 22 is provided. Note, however, that this does not imply any limitation on the present embodiment. If necessary, color filters of R (red), G (green), and B (blue) and a black matrix etc. (all of which are not illustrated) can be provided between the glass substrate 21 and the alignment film 22. In other words, the substrate 20 can be a color filter substrate on which color filters (not illustrated) are provided in addition to the alignment film 22.

It is needless to say that each of the substrates 10 and 20 can be provided with an undercoating film or an overcoating film (both of which are not illustrated).

The alignment film 22 is, like the alignment film 15, a so-called vertical alignment film. The alignment film 22 is provided all over the entire display region of the substrate 20, as with the alignment film 15 which is provided all over the entire display region of the substrate 10.

<Material of Each Layer of Substrates 10 and 20 and Method for Forming Each Layer>

The following description discusses an example of a material of each layer of the substrates 10 and 20 and a method for forming the each layer.

Examples of materials suitable for the lower layer electrode 12 and the upper layer electrode 14 include transparent electrode materials such as ITO (Indium Tin Oxide) and IZO (Indium Zing Oxide). Note however that, in a case where the substrate 10 is used as a substrate on the back surface side as described earlier, the lower layer electrode 12 and the upper layer electrode 14 do not necessarily have to be transparent electrodes, and can be constituted by metal electrodes made of aluminum etc. These electrodes can be made of the same electrode material or can be made of respective different electrode materials.

A method of forming (stacking) those electrodes is not particularly limited. Any known methods such as a sputtering method, vacuum deposition, and a plasma CVD method can be employed. Further, the method of patterning the upper layer electrode 14, which is one of those electrodes, is also not limited. Any known patterning methods such as photolithography can be employed.

Thickness of each of the electrodes is not particularly limited, but is preferably set within a range from 100 Å to 2000 Å.

Further, the insulating layer 13 can be an inorganic insulating film made of an inorganic insulating material such as silicon nitride (SiN) (relative permittivity ε is 6.9, described later). Alternatively, the insulating layer 13 can be an organic insulating film made of an organic insulating material such as an acrylic resin (relative permittivity ε is for example 3.7).

Thickness of the insulating layer 13 is smaller than an electrode spacing between adjacent electrode parts 14A (i.e., a distance between adjacent branch electrodes, which distance serves as a space).

Thickness of the insulating layer 13 is set for example within a range from 1000 Å to 30000 Å, although it depends on the type of the insulating layer 13 (for example, whether the insulating layer is an inorganic insulating film or an organic insulating film).

Thickness of the insulating layer 13 is not particularly limited, and can be set as appropriate according to the type of the insulating layer 13. Note, however, that a smaller thickness is preferable because the insulating layer 13 having a smaller thickness allows the liquid crystal molecules 31 to move well and the liquid crystal panel 2 to be thinner. However, in order to prevent insulation failure and unevenness in thickness due to lattice defect, it is preferable that the thickness of the insulating layer 13 is not less than 1000 Å.

A method for forming (stacking) the insulating layer 13 is not particularly limited. Any known methods such as a sputtering method, vacuum deposition, a plasma CVD method, and coating can be employed depending on an insulating material to be used.

Note that materials of and a method for forming the alignment films 15 and 22 will be separately described later in detail.

<Liquid Crystal Layer 30>

The liquid crystal cell 5 of the liquid crystal panel 2 is formed by for example (i) bonding the substrate 10 and the substrate 20 together with a sealing material (not illustrated) via a spacer(s) (not illustrated) and (ii) sealing-in a medium containing a liquid crystal material in a space between the substrates 10 and 20.

The liquid crystal material can be a p(positive)-type liquid crystal material or an n(negative)-type liquid crystal material.

Note that the present embodiment mainly discusses an example in which a p-type liquid crystal material is used as the liquid crystal material, as shown in FIG. 2 and Examples (described later). Note, however, that this does not imply any limitation on the present embodiment. Even in a case where an n-type liquid crystal material is used as the liquid crystal material, the same result can be obtained by the same principle as applies to a case where the p-type liquid crystal material is used.

Further, the p-type liquid crystal material used in the present embodiment is for example a p-type nematic liquid crystal material. Note, however, that the present embodiment is not limited to this.

The liquid crystal panel 2 and the liquid crystal display device 1 are configured to form, by applying an electric field, an electric field intensity distribution in the liquid crystal cell 5 to thereby realize bend orientation of the liquid crystal material. In the present embodiment, a liquid crystal material having a large refractive index anisotropy Δn or a liquid crystal material having a large dielectric anisotropy Δε is suitably used.

Examples of such p-type liquid crystal materials include a cyano (CN) liquid crystal material (chiral nematic liquid crystal material) as well as a fluorinated (F) liquid crystal material. <Display Mode of Liquid Crystal Panel 2>

The following description discusses, with reference to FIG. 1, a vertical-alignment transverse electric field mode which is a display mode of the liquid crystal panel 2.

As described earlier, the substrate 10 has a configuration similar to a configuration of an electrode substrate (array substrate) of a liquid crystal panel employing a so-called FFS display mode, in which a common electrode and pixel electrodes are arranged so as to overlap each other via an insulating layer. Therefore, a substrate having the above configuration is hereinafter referred to as a substrate having an FFS structure, and a liquid crystal panel having the above configuration is hereinafter referred to as a liquid crystal panel having an FFS structure.

Note, however, that the liquid crystal panel 2 according to the present embodiment is one in which the foregoing FFS structure is employed only in the electrode configuration of the substrate 10, and thus is different from a so-called FFS mode liquid crystal panel (See Patent Literature 3, for example).

According to the FFS mode, long axes of liquid crystal molecules which are provided between a pair of substrates are parallel to surfaces of the pair of the substrates, i.e., the liquid crystal molecules are in homogeneous alignment, while no electric field is applied. On the other hand, according to the liquid crystal panel 2 in accordance with the present embodiment, long axes of liquid crystal molecules 31 which are provided between a pair of substrates (the substrates 10 and 20) are perpendicular to surfaces of the pair of substrates, i.e., the liquid crystal molecules 31 are in homeotropic alignment, while no electric field is applied. Therefore, the liquid crystal panel 2 of the present embodiment is completely different from the FFS mode in terms of how the liquid crystal molecules 31 behave.

Further, according to the FFS mode, a display is carried out in the following manner. Assume that (i) the electrode width of a branch electrode constituting an electrode part 14A is L and the electrode spacing (which is a distance between adjacent electrode parts 14A, i.e., a distance between adjacent branch electrodes), which is a space, is S as described earlier and (ii) a cell gap (thickness of a liquid crystal layer) is D. The display is carried out by causing a so-called fringe electric field to be generated, by employing a configuration in which the electrode spacing S is smaller than the electrode width L and the cell gap D.

On the other hand, according to the present embodiment, the electrode spacing S is set to be larger than the cell gap D as described in Examples (described later). Note however that, in the present invention, the transmittance of the liquid crystal cell 5 as a whole and the cell gap D are not necessarily related to each other. Therefore, the cell gap D is not particularly limited.

In the liquid crystal panel 2, the lower layer electrode 12 functions as a common electrode, and the upper layer electrode 14 functions as a pixel electrode. The upper layer electrode 14 is connected to a signal line and a switching element such as a TFT via a drain electrode (not illustrated). Signals based on video signals are applied to the upper layer electrode 14.

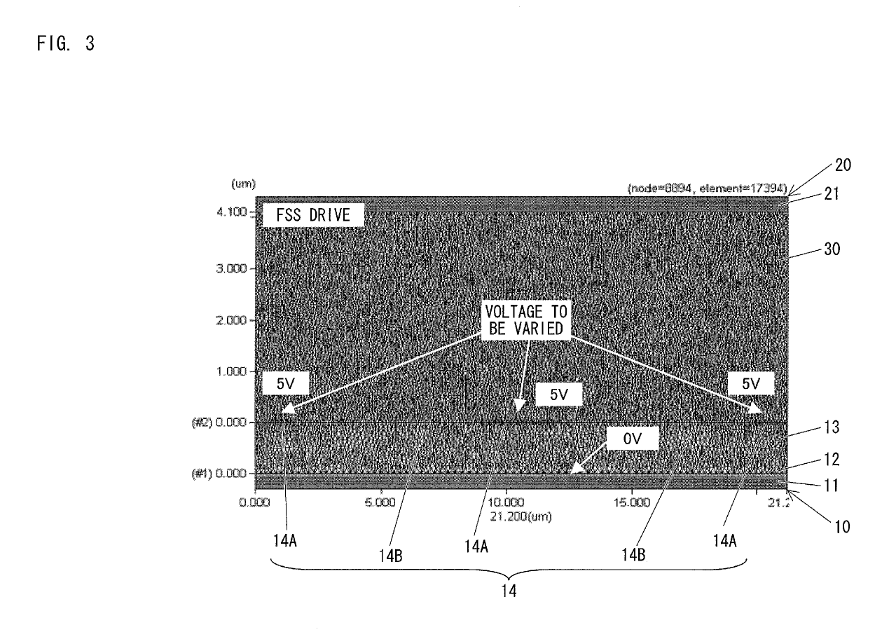

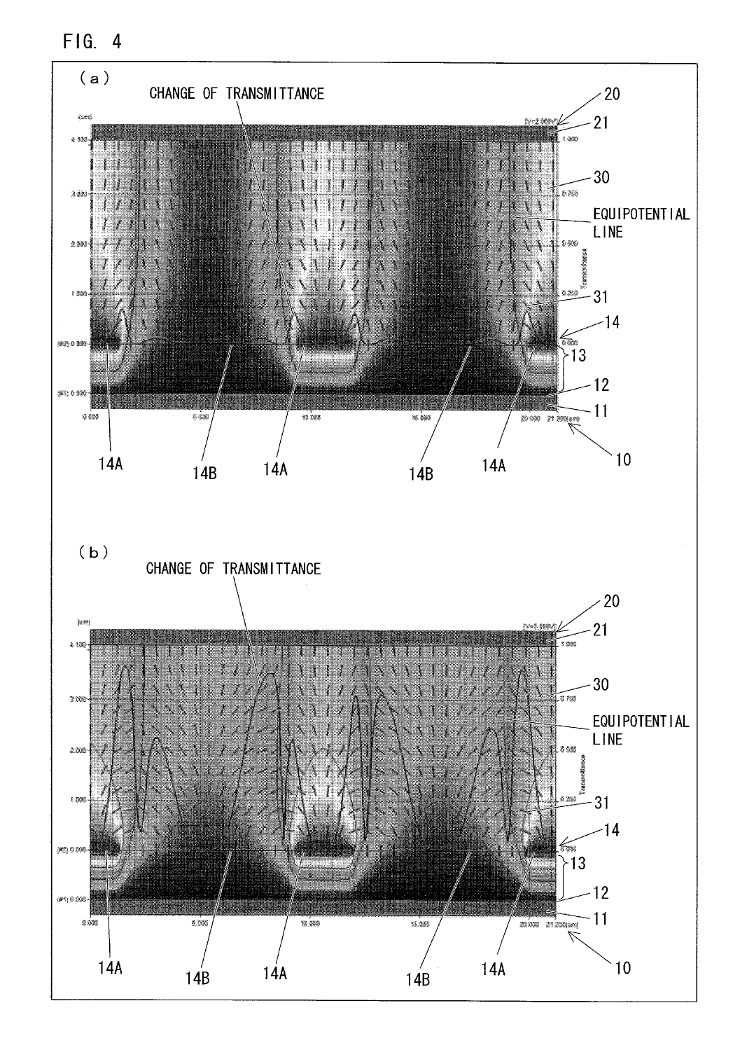

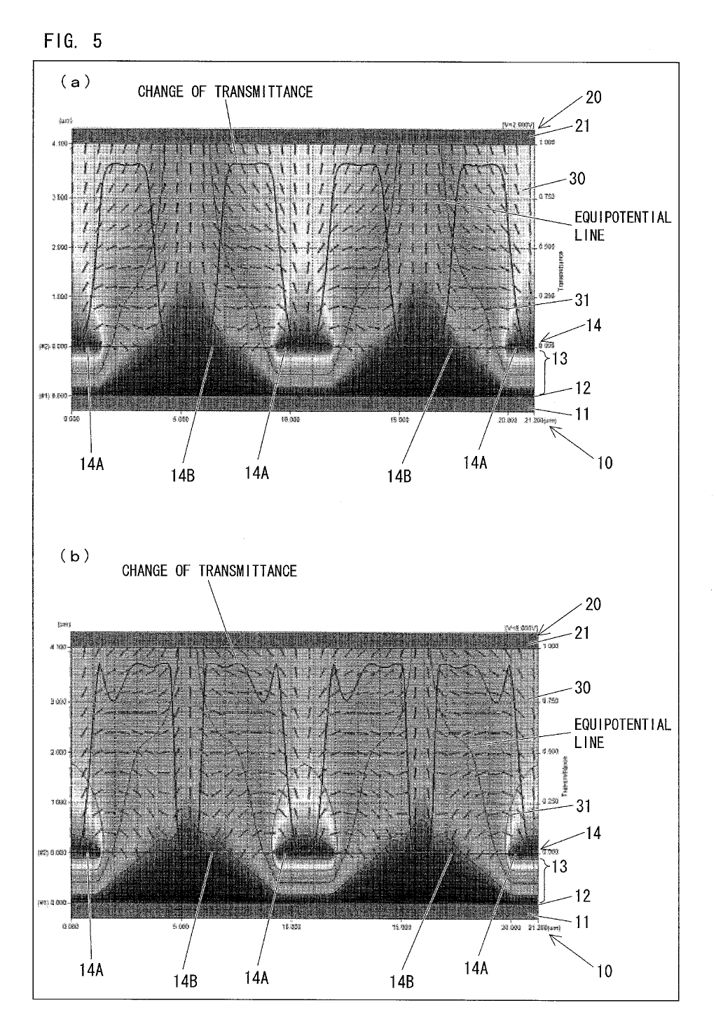

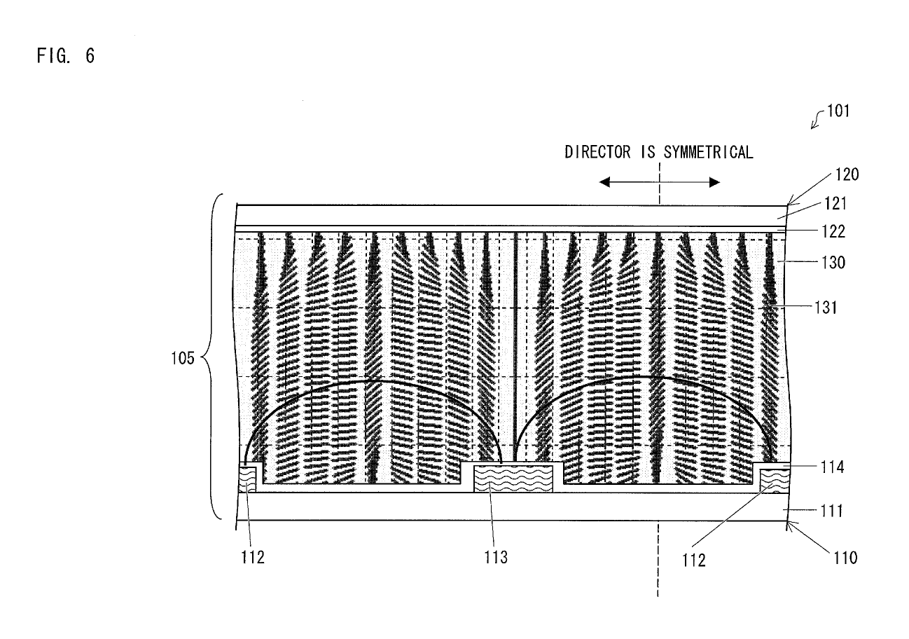

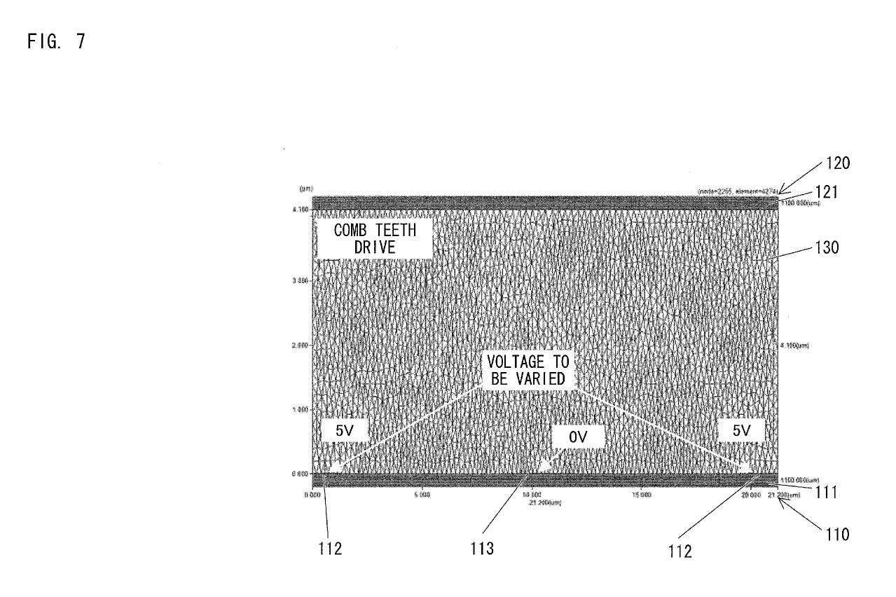

FIG. 3 is a view showing an example what voltages are applied to the upper layer electrode 14 and the lower layer electrode 12 of the liquid crystal cell 5.

According to the present embodiment, for example, a voltage applied to the lower layer electrode 12 is set at 0 V (as shown in FIG. 3), and a voltage applied to the upper electrode 14 (i.e., each electrode part 14A) is varied (as will be described later in Examples). Note that, as shown in FIG. 3, the same voltage is applied to the each electrode part 14A. FIG. 3 shows an example in which a voltage of 5 V is applied to the each electrode part 14A.

As described earlier, the liquid crystal panel 2 has a configuration in which vertical alignment films serving as the alignment films 15 and 22 are provided on the surfaces of the respective substrates 10 and 20. Therefore, the liquid crystal molecules 31 in the liquid crystal panel 2 are aligned perpendicularly to the surfaces of the substrates while no electric field is applied.

In the liquid crystal panel 2, a display is carried out by applying a potential difference between the upper layer electrode 14 and the lower layer electrode 12 of the substrate 10. The potential difference causes a transverse electric field between the upper layer electrode 14 and the lower layer electrode 12, and lines of electric force between the upper layer electrode 14 and the lower layer electrode 12 are bent in a semicircular shape. The liquid crystal molecules 31 are aligned according to (i) an electric field intensity distribution within the liquid crystal cell 5 and (ii) anchoring force from interfaces.

This causes the liquid crystal molecules 31 to be in a bend orientation state so as to form an arc shape along a thickness direction of a substrate (see FIG. 1), in a case where a p-type liquid crystal material is used. Note that, in a case where an n-type liquid crystal material is used, the liquid crystal molecules 31 are caused to be in a bend orientation state so as to form an arc shape along an in-plane direction of a substrate. Because of this, in either case, the liquid crystal panel 2 causes birefringence of light that travels in a direction perpendicular to a surface of a substrate.

As described above, according to the liquid crystal panel 2, a display is carried out by controlling the amount of light that passes therethrough, by causing the liquid crystal molecules 31 to be rotated by a transverse electric field generated between the upper layer electrode 14 and the lower layer electrode 12 of the substrate 10.

The liquid crystal molecules 31 continuously change from the homeotropic orientation state into the bend orientation state in response to a voltage. As a result, in a case of usual driving, the liquid crystal layer 30 always shows a bend orientation as shown in FIG. 1, and a high-speed response can thus be achieved in a transition from one gray scale level to another.

Further, in this mode, as described above, the directions in which the liquid crystal molecules 31 are oriented are determined by driving the liquid crystal molecules 31 by a transverse electric field while keeping a high contrast attributed to vertical alignment. Therefore, unlike an MVA mode, it is not necessary to control alignment by projections, and thus an excellent wide viewing angle is achieved with a simple pixel configuration.

Further, by carrying out a driving with a transverse electric field in a vertical alignment mode as described above, a bent (arc-shaped) electric field is formed in response to voltage application. Accordingly, two domains in which their director directions are different from each other by substantially 180 degrees are formed between adjacent electrode parts 14A (i.e., adjacent branch electrodes), and thereby a wide viewing angle is achieved.

Accordingly, the liquid crystal panel 2 is not only simple in configuration and thus easy to manufacture at low cost, but also capable of achieving (i) high-speed response attributed to bend orientation, (ii) a wide viewing angle attributed to self-compensating alignment, and (iii) a high contrast attributed to vertical alignment.

### <Materials for Alignment Films 15 and 22 and Method for Forming Alignment Films 15 and 22>

The following description discusses materials for the alignment films 15 and 22 and a method for forming the alignment films 15 and 22.

Each of the alignment films 15 and 22 can be formed by for example applying, on (i) the upper layer electrode 14 and the insulating layer 13 in the space 14B or (ii) the glass substrate 21, an alignment film material which has a force to achieve vertical alignment.

The alignment films 15 and 22 used in the present embodiment are alignment films each of which has a polar anchoring energy (polar anchoring strength) falling within a range from more than 5×10⁻⁶ J/m² to not more than 1×10⁻⁴ J/m².

Note that polar anchoring energy of a general polyimide-type organic alignment film is 5×10⁻⁴ J/m². Therefore, assuming that the polar anchoring energy (5×10⁻⁴ J/m²) of the general polyimide-type organic alignment film is 100%, each of the alignment films 15 and 22 used in the present embodiment is an alignment film which has a polar anchoring energy falling within a range from more than 1% (5×10⁻⁶ J/m²) to not more than 50% (1×10⁻⁴ J/m²) of the polar anchoring energy (5×10⁻⁴ J/m²) of the general polyimide-type organic alignment film.

In the present embodiment, it is desirable to set the polar anchoring energy of each of the alignment films 15 and 22 as weak as possible within the foregoing range. The polar anchoring energy of each of the alignment films 15 and 22 is preferably not more than 10% (5×10⁻⁵ J/m²), and more preferably not more than 2% (1×10⁻⁵ J/m²), of the polar anchoring energy (5×10⁻⁴ J/m²) of the general polyimide-type organic alignment film.

Examples of an alignment film material that has such a polar anchoring energy include an optical alignment film material and an inorganic alignment film material.

<Optical Alignment Film>

The following description discusses one example of an optical alignment film.

The optical alignment film used in the present embodiment is an alignment film which has a vertical alignment property. The alignment film is made of a side-chain polymer that has a photoreactive functional group(s) at its side chain, which photoreactive functional group(s) react(s) (dimerize, polymerize, and/or cross-link) due to interaction with light.

Such an optical alignment film is made of for example a polyimide which has, at its side chain, a cinnamate group represented by the following structural formula (1):

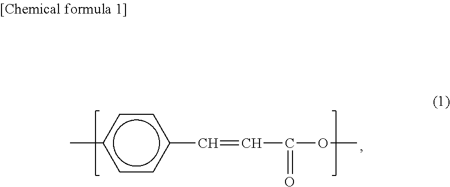

which cinnamate group serves as a photoreacive functional group (refer to Patent Literature 4, for example).

Such an optical alignment film generally has a small polar anchoring energy, because the side chain (i.e., a photoreactive functional group having a vertical alignment property) is a straight chain and is flexible.

Further, the optical alignment film is formed by (i) applying an optical alignment film material to a substrate, and thereafter (ii) heating and drying the optical alignment film material to obtain a film, and (iii) irradiating the film with polarized light. Such an optical alignment film has a characteristic that makes it possible to control alignment of liquid crystal molecules according to a direction of the polarized light, which was used to form the optical alignment film.

Note that the photoreactive functional group can be located at any part of the side chain, and can be close to a main chain or can be at an end of the side chain.

<Method for Forming Optical Alignment Film and Method for Manufacturing Liquid Crystal Panel>

First, the following description discusses a method for forming an optical alignment film. Such an optical alignment film is formed in the following manner.

First, an optical alignment film material diluted with a solvent is applied, to a substrate on which the optical alignment film is to be formed, by printing, ink-jet technology or spin-coating etc. so that the optical alignment film has a desirable thickness. After that, the substrate is heated in an atmosphere at a temperature required to dry the solvent, thereby a desired optical alignment film is formed on the substrate.

Note that, it is needless to say that, even if the substrate is irradiated with light that causes a reaction of a photoreactive functional group of a polymer which constitutes the alignment film, a vertical alignment property is not impaired. The light can be polarized light. Therefore, the liquid crystal panel 2 can be constituted by (i) substrates which have subjected to the above process, which substrates serve as the substrates 10 and 20 and (ii) the liquid crystal layer 30 which is sandwiched between the substrates so that a desired gap is kept.

In a case where light irradiation is carried out with respect to a substrate or a liquid crystal panel, for example a high pressure mercury lamp which generates an ultraviolet ray can be used. The photoreactive functional group reacts with the ultraviolet ray. Such irradiation can be carried out with an ultraviolet ray that has a wavelength of 335 nm and an irradiation energy of not more than 1 J/cm².

As described above, in a case where optical alignment films serving as the alignment films 15 and 22 are to be formed, it is preferable that the optical alignment films are irradiated with polarized light having a wavelength of 335 nm and an irradiation energy of not more than 1 J/cm².

This makes it possible to form, on the substrate, an optical alignment film that has a vertical alignment property and has a small polar anchoring energy.

Polar anchoring energy varies depending on not only an alignment film material but also surface roughness of the alignment films 15 and 22 (i.e., base on which the alignment film to be formed).

<Anchoring Energy>

Anchoring energy indicates to what degree liquid crystal molecules are anchored by an alignment film. The anchoring energy is categorized into the following two types: (i) polar anchoring energy which indicates how strong liquid crystal molecules, which are at a surface (interface) of a liquid crystal layer which surface is in contact with the alignment film, are anchored with respect to a polar angle direction and (ii) azimuthal anchoring energy which indicates how the liquid crystal molecules at the interface are anchored with respect to an azimuth angle direction.

Note that it is known that, according to a liquid crystal panel employing a transverse electric field mode, since liquid crystal molecules basically move within a plane that is parallel to a surface of a substrate, the azimuthal anchoring energy influences how alignment of the liquid crystal molecules is changed.

For example, Patent Literature 3 discloses the following technique. That is, in a horizontal alignment-type liquid crystal panel in which a display is carried out by applying a transverse electric field, for the purpose of reducing a relaxation time which is necessary for relaxation of changes in alignment of liquid crystal molecules due to ON/OFF of signals, the azimuthal anchoring energy of an alignment film provided on a substrate on which electrodes are formed is reduced so as to be smaller than that of an alignment film provided on a counter substrate.

On the other hand, the inventors of the present invention have found the following. In a vertical alignment-type liquid crystal panel 2 which has an FFS structure as shown in FIG. 1 and in which a display is carried out by applying a transverse electric field, the polar anchoring energy of the alignment films 15 and 22 (vertical alignment films) influences a voltage-transmittance (V-T) characteristic. The polar anchoring energy here is, assuming that a normal to a substrate is z axis, anchoring energy (polar anchoring energy) which causes liquid crystal molecules, which are at a surface (interface) of the liquid crystal layer which surface is in contact with the alignment film, to be anchored with respect to a rotational direction in which they rise from a surface of the substrate.

As described earlier, according to the liquid crystal panel 2 which has an FFS structure, the upper layer electrode 14 constituted by a comb electrode and the lower layer electrode 12 constituted by an allover electrode are provided on an identical substrate, i.e., the substrate 10. Since an electrode spacing between the upper layer substrate 14 and the lower layer substrate 12 is smaller than an electrode spacing S between adjacent electrode parts 14A (adjacent branch electrodes) of the upper layer electrode 14, an electric field to be generated between the upper layer electrode 14 and the lower layer electrode 12 is stronger than that to be generated between the upper layer electrode 14 and the lower layer electrode 12 even if the same driving voltage is applied.

Therefore, according to the liquid crystal panel 2 which has the foregoing FFS structure, the liquid crystal molecules 31 near the upper layer electrode 14 (that is, each of the electrode parts 14A) on the substrate 10 respond to a low voltage as compared to a liquid crystal panel without the FFS structure. Accordingly, the liquid crystal panel 2 can be operated at a lower voltage.

Note, however, that the following problem arises. As described earlier, electric fields are generated only between electrodes provided on the substrate 10 which is provided for example on the lower side as shown in FIG. 1. Therefore, the liquid crystal molecules 31 in an upper portion (i.e., on the substrate 20 side) of the liquid crystal cell 5 or in a central portion of a space between adjacent electrode sections 14A (a space between branch electrodes), in which portions electric fields are weak, are difficult to respond. This causes a reduction in transmittance.

The inventors of the present invention have diligently studied and found that, in a case where the liquid crystal panel 2 having the FFS structure as described earlier employs a general organic alignment film such as a polyimide-type organic alignment film which is generally known to show strong anchoring, transmittance after rise is lower than a liquid crystal panel 101 (shown in FIG. 6) which does not have the FFS structure and drives a liquid crystal layer 130 by a transverse electric field between comb electrodes 112 and 113.

According to the present embodiment, by reducing the polar anchoring energy of the alignment films 15 and 22, the liquid crystal molecules 31 are caused to be easy to respond to an electric field. This makes it possible to reduce a voltage necessary for driving and to achieve high transmittance.

Note that, as described earlier, examples of a method of reducing the polar anchoring energy of the alignment films 15 and 22 include: (I) producing each of the alignment films 15 and 22 from an alignment film material that has a small anchoring energy such as an optical alignment film material, (II) increasing the surface roughness of each of the alignment films 15 and 22, and (III) using an alignment film material that has a small anchoring energy such as an inorganic alignment film.

Accordingly, the alignment films 15 and 22 each of which has a desired polar anchoring energy, can be formed by a method selected as appropriate from the methods (I) to (III).

Note that the polar anchoring energy varies depending on for example (i) an alignment film material from which the alignment films 15 and 22 are made and/or (ii) the surface roughness (base on which an alignment film is to be formed) of the alignment films 15 and 22. Therefore, the desired polar anchoring energy can be obtained by selecting an alignment film material and/or the surface roughness as appropriate, and how to obtain the desired polar anchoring energy is not particularly limited.

The following description discusses more specifically a method for manufacturing the liquid crystal panel 2 by using Examples and Comparative Examples, and verifies the foregoing effects by tests and simulations.

### COMPARATIVE EXAMPLE 1

First, as shown in FIG. 1, a film of ITO was formed on an entire surface of a glass substrate 11 by a sputtering method so that the film had a thickness of 1400 Å. In this way, an allover lower layer electrode 12, which covers the entire main surface of the glass substrate 11, was formed.

Next, a film of silicon nitride (SiN) having a relative permittivity ε of 6.9 was formed by a sputtering method so as to cover an entire surface of the lower layer electrode 12. In this way, an insulating layer 13 made of the SiN and having a thickness d of 3000 Å (0.3 μm) was formed on the lower layer electrode 12.

Next, comb electrodes 14A and 14B made of ITO and serve as an upper layer electrode 14 were formed on the insulating layer 13 so that their thickness was 1400 Å, the electrode width L was 2.5 μm, and the electrode spacing S was 8.0 μm.

Next, an alignment film material “JALS-204” (product name, solid content 5 wt. %, γ-butyrolactone solution, polyimide-type organic alignment film material) produced by JSR Corporation was applied to the insulating layer 13 by spin coating so as to cover the comb electrodes 14A and 14B. Thereafter, the alignment film material was baked at 200° C. for 2 hours. In this way, a substrate 10, which has an alignment film 15 on its surface facing a liquid crystal layer 30, was obtained. The alignment film is a vertical alignment film.

Meanwhile, an alignment film 22 only was formed on a glass substrate 21 with use of the same material as the alignment film 15 in the same manner as in the alignment film 15. In this way, a substrate 20 was formed.

The alignment films 15 and 22 thus obtained each had a dry thickness of 1000 Å. Further, polar anchoring energy of each of the alignment films 15 and 22 was measured and found to be 5×10⁻⁴ J/m². The polar anchoring energy was measured with use of “EC 1” produced by Toyo Corporation.

After that, resin beads “Micropearl SP 20375” (product name, produced by Sekisui Chemical Co., Ltd.) each having a diameter of 3.75 μm and serving as a spacer (not illustrated) were dispersed on either one of the substrates 10 and 20 which are to face each other. Meanwhile, on the other of the substrates 10 and 20, a sealing resin “Struct Bond XN-21S” (product name, produced by Mitsui Toatsu Chemicals, Inc.) which serves as a sealing agent (not illustrated) was printed.

Next, the substrates 10 and 20 were bonded together and baked at 135° C. for 1 hour. In this way, a liquid crystal cell 5 was produced.

Thereafter, a p-type liquid crystal material produced by Merck Ltd. (Δε=22, Δn=0.15), which serves as a liquid crystal material, was sealed in the liquid crystal cell 5 by a vacuum injection method. In this way, a liquid crystal layer 30 was formed.

Next, polarizing plates 6 and 7 were bonded to the front and back surfaces of the liquid crystal cell 5, respectively, such that (i) transmission axes of the polarizing plates 6 and 7 are orthogonal to each other and (ii) a direction in which each electrode part 14A (branch electrode) extends (see FIG. 1) is at degrees to the transmission axes of the polarizing plates 6 and 7. In this way, a liquid crystal panel 2 configured as shown in FIG. 1 was produced.

The liquid crystal panel 2 thus produced was placed above a backlight 4 as shown in FIG. 2, and a change in “voltage versus transmittance” (hereinafter referred to as “actual value T”) of the liquid crystal panel 2 when viewed from a front direction was measured by “BM5A” produced by Topcon Corporation. Note that the transmittance in the actual value T was found by dividing luminance of the liquid crystal panel 2 by luminance of the backlight 4.

Meanwhile, a model of the liquid crystal panel was prepared. The model of the liquid crystal panel 2 has the FSS structure as shown in FIG. 1, and is configured such that the electrode width L is 2.5 μm, the electrode spacing S is 8.0 μm and the thickness d of the insulating layer 13 is 3000 Å. A change in “voltage versus transmittance” (hereinafter referred to as “SimT”) of the model of the liquid crystal panel 2, which are to be observed when the model of the liquid crystal panel 2 is operated under the same conditions as in the foregoing actual measurement, was found by simulation using “LCD-MASTER” produced by SHINTECH, Inc. Further, how liquid crystal molecules in the liquid crystal panel 2 are aligned was checked visually.

The SimT, the actual value T, polar anchoring energy of each of the alignment films 15 and 22, the relative permittivity ε and the thickness d of the insulating layer 13, driving method, and the result of visual check of alignment are all shown in Table 1.

Note that, in Table 1, “Poor” in the line of “Visual check of alignment” indicates that vertical alignment of the liquid crystal molecules 31 was not realized, and “Good” indicates that the liquid crystal molecules 31 are well aligned when checked visually. Further, in Table 1, “FFS drive” means that the liquid crystal layer 30 is driven by applying a transverse electric field between the upper layer electrode 14 and the lower layer electrode 12 of the liquid crystal panel 2 which has the FFS structure. Further, “Comb drive” means that the liquid crystal layer 130 is driven by applying a transverse electric field between the comb electrodes 112 and 113 of the liquid crystal panel 101 which has a comb structure in which only the comb electrodes 112 and 113 are provided as electrodes to which a transverse electric field is to be applied (shown in FIG. 6, described later).

Further, transmittances, director distributions of the liquid crystal molecules 31, and equipotential lines, which are observed when a voltage of 2 V and a voltage of 5 V are applied to the upper layer electrode 14 in the simulation, are shown in (a) and (b) of FIG. 4, respectively.

### EXAMPLE 1

The same operations as in Comparative Example 1 were carried out except that, instead of the alignment films 15 and 22 each of which has a polar anchoring energy of 5×10⁻⁴ J/m² and is made of an alignment film material “JALS-204” produced by JSR Corporation (a general polyimide-type organic alignment film material), alignment films 15 and 22 each of which has a polar anchoring energy of 5×10⁻⁵ J/m² and is made of an optical alignment film material were produced under the same conditions as in Comparative Example 1. In this way, a liquid crystal panel 2 in accordance with the present embodiment was produced.

The liquid crystal panel 2 thus produced was placed above a backlight 4, and the actual value T was measured in the same manner as in Comparative Example 1. Further, with use of a model of the liquid crystal panel 2 which has an FFS structure having the same conditions as that used in the actual measurement, the same operations as in Comparative Example 1 were carried out to find the SimT. Further, how liquid crystal molecules are aligned in the liquid crystal panel 2 was checked visually.

The SimT, the actual value T, the polar anchoring energy of the alignment films 15 and 22, the relative permittivity ε and the thickness d of the insulating layer 13, driving method, and the result of visual check of alignment are all shown in Table 1.

Note that the SimT and the actual value T obtained in Example 1 are similar to each other and those obtained in Comparative Example 1 are similar to each other as shown in Table 1. The SimT and the actual value T show similar V-T curves. In view of this, in the following Examples and Comparative Examples, only simulations were carried out to measure the V-T.

### Example 2, Example 3, Comparative Example 2

As described in Example 1, the polar anchoring energy of each of the alignment films 15 and 22 each made of an optical alignment film material was measured and found to be 5×10⁻⁵ J/m², which was 10% of the polar anchoring energy of a general organic alignment film.

Under such circumstances, the same operations as in Comparative Example 1 were repeated to find the SimT, with use of a model of the liquid crystal panel 2 which has the same FFS structure as in Comparative Example 1. In Example 2, the polar anchoring energy of each of the alignment films 15 and 22 was set to be 50% (1×10⁻⁴ J/m²) of the polar anchoring energy (5×10⁻⁴ J/m²) of each of the alignment films 15 and 22 used in Comparative Example 1. In Example 3, the polar anchoring energy was set to be 2% (1×10⁻⁵ J/m²) of that of Comparative Example 1. In Comparative Example 2, the polar anchoring energy was set to be 1% (5×10⁻⁶ J/m²) of that in Comparative Example 1. Further, how liquid crystal molecules are aligned in each of the liquid crystal panels 2 used in Examples and 3 and Comparative Example 2 was checked visually.

The SimT, the polar anchoring energy of the alignment films 15 and 22, the relative permittivity ε and the thickness d of the insulating layer 13, driving method, and the result of visual check of alignment are all shown in Table 1.

Further, in the simulation in which the polar anchoring energy of each of the alignment films 15 and 22 was 2% (1×10⁻⁵ J/m²) as described in Example 3, a voltage of 2 V and a voltage of 5 V were applied to the upper layer electrode 14. The transmittances, director distributions of the liquid crystal molecules 31, and equipotential lines, which were obtained when the voltage of 2 V and the voltage of 5 V were applied to the upper layer electrode 14, are shown in (a) and (b) of FIG. 5, respectively.

### COMPARATIVE EXAMPLE 3

First, as shown in FIG. 6, a film of ITO was formed by a sputtering method on an entire surface of a glass substrate 111 which is similar to the glass substrate 11 so that the film had a thickness of 1400 Å. After that, a resulted ITO film was patterned, thereby a comb electrode 112 serving as a pixel electrode and a comb electrode 113 serving as a common electrode, each of which is constituted by the ITO film, were formed on the glass substrate 111. Each of the comb electrodes 112 and 113 is such that the electrode width L is 2.5 μm and the electrode spacing S is 8.0 μm.

Next, an alignment film material “JALS-204” produced by JSR Corporation (polyimide-type organic alignment film material), which was also used in Comparative Example 1, was applied to the glass substrate 111 by spin coating so as to cover the comb electrodes 112 and 113. Thereafter, the alignment film material was baked at 200° C. for 2 hours in the same manner as in Comparative Example 1. In this way, a substrate 110 which has an alignment film 114 on its surface facing a liquid crystal layer 130 was obtained. The alignment film is a vertical alignment film.

Meanwhile, an alignment film 122 (vertical alignment film) only was formed on a glass substrate 121 which is similar to the glass substrate 21, with use of the same material as the foregoing vertical alignment film and in the same manner as in the foregoing vertical alignment film. In this way, a substrate 120 was formed. The dry thickness of each vertical alignment film thus obtained was 1000 Å.

After that, the same resin beads as is used in Comparative Example 1, i.e., “Micropearl SP20375” each having a diameter of 3.75 μm and serving as a spacer, were dispersed on either one of the substrates 110 and 120 which are to face each other. Meanwhile, on the other of the substrates 110 and 120, the same sealing resin as is used in Comparative Example 1, i.e., “Struct Bond XN-21S” which serves as a sealing agent was printed.

Next, the substrates 110 and 120 were bonded together and baked at 135° C. for 1 hour in the same manner as in Comparative Example 1. In this way, a liquid crystal cell 105 for comparison purposes was produced.

Thereafter, the same p-type liquid crystal material as is used in Example 1, i.e., the p-type liquid crystal material produced by Merck Ltd. (Δε=22, Δn=0.15) and serves as a liquid crystal material, was sealed in the liquid crystal cell 105 by a vacuum injection method. In this way, a liquid crystal layer 130 was formed.

Next, polarizing plates (not illustrated), which are the same as those used in Comparative Example 1, were bonded to the front and back surfaces of the liquid crystal cell 105, respectively, such that (i) transmission axes of the polarizing plates are orthogonal to each other and (ii) a direction in which each of the comb electrodes 112 and 113 extends is at 45 degrees to the transmission axes of the polarizing plates. In this way, a liquid crystal panel 101 for comparison purposes, which is configured as shown in FIG. 6, was produced.

The liquid crystal panel 101 thus produced was placed above a backlight in the same manner as in Comparative Example 1, and the actual value T was measured in the same manner as in Comparative Example 1. Further, with use of a model of the liquid crystal panel 101 which has the same comb structure as that used in the actual measurement, the same operations as in Comparative Example 1 were carried out to find the SimT. Further, how liquid crystal molecules were aligned in the liquid crystal panel 101 was checked visually.

The SimT, the actual value T, polar anchoring energy of the alignment films 15 and 22, the relative permittivity ε and the thickness d of the insulating layer 13, driving method, and the result of visual check of alignment are all shown in Table 1.

Note that the SimT and the actual value T obtained in Comparative Example 2 are similar to each other as shown in Table 1. The SimT and the actual value T show similar V-T curves. In view of this, also in the following Comparative Example using the liquid crystal panel 101, only simulations were carried out to measure the V-T.

### COMPARATIVE EXAMPLE 4

The same operations as in Comparative Example 2 were repeated to find the SimT, with use of a model of the liquid crystal panel 101 which has the same comb structure as in Comparative Example 2, except that the polar anchoring energy of each of the alignment films 114 and 122 was 2% (1×10⁻⁵ J/m²) of the polar anchoring energy (5×10⁻⁴ J/m²) of each of the alignment films 114 and 122. Further, how liquid crystal molecules were aligned in the liquid crystal panel 101 was checked visually.

The SimT, the polar anchoring energy of each of the alignment films 15 and 22, the relative permittivity ε and the thickness d of the insulating layer 13, driving method, and the result of visual check of alignment are all shown in Table 1.

TABLE 1

| | | COMPARATIVE | EXAM- | EXAM- | EXAM- | COMPARATIVE | COMPARATIVE | COMPARATIVE |
|---|---|---|---|---|---|---|---|---|
| | | EXAMPLE 1 | PLE 2 | PLE 1 | PLE 3 | EXAMPLE 2 | EXAMPLE 3 | EXAMPLE 4 |
| POLAR ANCHORING | | 5 × 10⁻⁴ | 1 × 10⁻⁴ | 5 × 10⁻⁵ | 1 × 10⁻⁵ | 5 × 10⁻⁶ | 5 × 10⁻⁴ | 1 × 10⁻⁵ |
| ENERGY (J/m²) | | | | | | | | |
| INTENSITY RATIO OF | | 100% | 50% | 10% | 2% | 1% | 100% | 2% |
| POLAR ANCHORING | | | | | | | | |
| ENERGY | | | | | | | | |
| RELATIVE | | 6.9 | 6.9 | 6.9 | 6.9 | 6.9 | NONE | NONE |
| PERMITTIVITY ε OF | | | | | | | | |
| INSULATING LAYER | | | | | | | | |
| THICKNESS d OF | | 3000 | 3000 | 3000 | 3000 | 3000 | NONE | NONE |
| INSULATING LAYER | | | | | | | | |
| (Å) | | | | | | | | |
| DRIVING METHOD | | FFS DRIVE | FFS DRIVE | FFS DRIVE | FFS DRIVE | FFS DRIVE | COMB | COMB |
| | | | | | | | DRIVE | DRIVE |
| SimT | 2.0 V | 1.3% | 1.5% | 8.4% | 17.2% | 19.6% | 0.0% | 0.0% |
| | 3.0 V | 6.1% | 6.3% | 20.2% | 21.9% | 23.0% | 0.4% | 19.9% |
| | 4.0 V | 9.8% | 13.7% | 22.5% | 23.3% | 23.7% | 19.2% | 20.9% |
| | 5.0 V | 14.8% | 17.8% | 23.2% | 23.8% | 23.9% | 23.4% | 21.0% |
| ACTUAL | 2.0 V | 1.4% | — | 8.2% | — | — | 0.0% | — |
| VALUE T | 3.0 V | 6.6% | — | 19.4% | — | — | 0.3% | — |
| | 4.0 V | 9.9% | — | 21.1% | — | — | 16.0% | — |
| | 5.0 V | 13.2% | — | 21.6% | — | — | 19.8% | — |

| | | | | | | | |
|---|---|---|---|---|---|---|---|
| VISUAL CHECK OF | Good | Good | Good | Good | Poor | Good | Good |
| ALIGNMENT | | | | | | | |

As is clear from (b) of FIG. 4, in a case where the liquid crystal panel 2 has an FFS structure, the following occurs. That is, in a case where the polar anchoring energy of each of the alignment films 15 and 22 is 5×10⁻⁴ J/m² as described in Comparative Example 1, the liquid crystal molecules 31 at surfaces (interfaces) of the liquid crystal layer 30 which surfaces are in contact with the respective alignment films 15 and 22 are not rotated even when a voltage of 5 V is applied. Note that the value of transmittance to be obtained is almost the same even in a case where the polar anchoring energy is greater than the aforementioned value.

Note however that, when the polar anchoring energy of each of the alignment films 15 and 22 decreases to 1×10⁻⁴ J/m² as described in Example 2, the liquid crystal molecules 31 at the interfaces start to rotate. Accordingly, less voltage is required and high transmittance is achieved as compared to Comparative Example 1 (a case where the liquid crystal molecules 31 at the interfaces are not rotated).

In other words, according to the liquid crystal panel 2 which has the FFS structure, less voltage is required and high transmittance is achieved when the polar anchoring energy is not more than 1×10⁻⁴ J/m². Therefore, it is desirable that the maximum value of the polar anchoring energy is 1×10⁻⁴ J/m².

Further, it was confirmed from the results of the simulations shown in Table 1 that, according to both (i) the liquid crystal panel 2 which has the FFS structure as described in Comparative Examples 1 and 2 and Examples 1 to 3 and (ii) the liquid crystal panel 2 which has the comb structure as described in Comparative Examples 3 and 4, less voltage is required as the polar anchoring energy becomes smaller.

This is probably because of the following reason. As is clear from a comparison between (a) of FIG. 4 and (a) of FIG. 5, in a case where the polar anchoring energy is small, liquid crystal molecules at surfaces (interfaces) of a liquid crystal layer which surfaces are in contact with respective alignment films are less anchored, and thus the liquid crystal molecules in a bulk are easy to rotate. Accordingly, the liquid crystal molecules in the bulk respond to lower voltages.

Note however that, as is clear from Comparative Examples 3 and 4, the liquid crystal panel 101 which has the comb structure has the following problem. That is, even if the polar anchoring energy is reduced to 2% of the anchoring energy (5×10⁻⁴ J/m²) of a general organic alignment film, the liquid crystal panel 101 requires higher voltage to cause liquid crystal molecules to rise as compared to the liquid crystal panel 1 which has the FFS structure and employs a general organic alignment film whose polar anchoring energy is 5×10⁻⁴ J/m² (as described in Comparative Example 1). Therefore, it is not possible to further reduce necessary voltage.

In contrast, according to the liquid crystal panel 2 which has the FFS structure, necessary voltage decreases noticeably as the polar anchoring energy becomes smaller. Further, as is clear from a comparison between (b) of FIG. 4 and (b) of FIG. 5, the transmittance obtained when a voltage of 5 V is applied is improved to the same or greater extent as compared to Comparative Example 3 which employs the comb drive. This makes it possible to reduce necessary voltage and increase transmittance.

Note that, according to the results of the simulations, it is expected that, as the polar anchoring energy becomes weaker, less voltage is required and greater transmittance is achieved in the FFS drive.

Note however that, as described in Comparative Example 2, the actual measurements showed that, when the polar anchoring energy of an alignment film is equal to or less than 1% of that of a general organic alignment film, liquid crystal molecules in a liquid crystal layer at the surfaces (interfaces) in contact with respective alignment films are anchored too weakly to be aligned vertically.

As has been described, it was confirmed that, by causing the polar anchoring energy of each of the alignment films 15 and 22 to be as weak as possible within a range from more than 1% (5×10⁻⁶ J/m²) to not more than 50% (1×10⁻⁴ J/m²) of the polar anchoring energy (5×10⁻⁴ J/m², 100%) of a general polyimide-type organic alignment film, less voltage is required and high transmittance is achieved without reducing display quality.

<Main Points of the Invention>

As has been described, a liquid crystal panel according to one embodiment of the present invention is a liquid crystal panel of a vertical alignment type, including: a first substrate on which (i) a lower layer electrode constituted by an allover electrode and (ii) an upper layer electrode constituted by a comb electrode are provided so as to overlap each other via an insulating layer; a second substrate which faces the first substrate; a liquid crystal layer sandwiched between the first substrate and the second substrate; and a first alignment film provided on the first substrate so as to be in contact with the liquid crystal layer and a second alignment film provided on the second substrate so as to be in contact with the liquid crystal layer, the first and second alignment films causing liquid crystal molecules in the liquid crystal layer to be aligned perpendicularly to the first and second substrates while no electric field is applied, the liquid crystal layer being driven by a transverse electric field which is generated between the lower layer electrode and the upper layer electrode provided on the first substrate, and the first and second vertical alignment films each having a polar anchoring energy falling within a range from more than 5×10⁻⁶ J/m² to not more than 1×10⁻⁴ J/m².

The polar anchoring energy is more preferably not more than 5×10⁻⁵ J/m², and further preferably not more than 1×10⁻⁵ J/m².

Further, a liquid crystal display device according to one embodiment of the present invention includes the liquid crystal panel.

The inventors of the present invention have found the following. The liquid crystal molecules at surfaces (interfaces) of the liquid crystal layer which surfaces are in contact with the vertical alignment films start to rotate when the polar anchoring energy of the vertical alignment films is reduced to 1×10⁻⁴ J/m², which is 50% of the polar anchoring energy of the general polyimide-type organic alignment film. With this, the liquid crystal panel requires less voltage and achieves higher transmittance as compared to a case where the aforementioned general polyimide-type organic alignment film is used (i.e., a case where the liquid crystal molecules at the interfaces do not rotate).

Moreover, the inventors of the present invention have conducted a further study, and found the following. As the polar anchoring energy becomes smaller, the liquid crystal panel requires less voltage and achieves higher transmittance. However, when the polar anchoring energy is less than or equal to 5×10⁻⁶ J/m², i.e., 1% of the polar anchoring energy of the general polyimide-type organic alignment film, vertical alignment of liquid crystal molecules cannot be realized because liquid crystal molecules in the liquid crystal layer at surfaces (interfaces) of the liquid crystal layer which surfaces are in contact with the alignment films are anchored too weakly.

Therefore, it is desirable to set the polar anchoring energy as weak as possible within a range from more than 5×10⁻⁶ J/m² to not more than 1×10⁻⁴ J/m². The polar anchoring energy is preferably not more than 10% (5×10⁻⁵ J/m²), and more preferably not more than 2% (1×10⁻⁵ J/m²) of the polar anchoring energy of the general polyimide-type organic alignment film.

The present invention is not limited to the descriptions of the respective embodiments, but may be altered within the scope of the claims. An embodiment derived from a proper combination of technical means disclosed in different embodiments is encompassed in the technical scope of the invention.

### INDUSTRIAL APPLICABILITY

A liquid crystal panel and a liquid crystal display device according to the present invention each have a high transmittance and are operable at a practical driving voltage. Further, an operation to initially cause a transition into a bend orientation is not necessary. This makes it possible to achieve all of the following:(i) a wide viewing angle characteristic equivalent to that of an MVA mode and an IPS mode, (ii) high speed responsivity equivalent to or greater than that of an OCB mode, and (iii) a high contrast. Accordingly, the liquid crystal panel and the liquid crystal display device according to the present invention are suitably applicable especially to a public bulletin board for outdoor use and mobile devices such as a mobile phone and PDA.

### REFERENCE SIGNS LIST

1 Liquid crystal display device
2 Liquid crystal panel
3 Drive circuit
4 Backlight
5 Liquid crystal cell
6 Polarizing plate
7 Polarizing plate
8 Phase plate
9 Phase plate
10 Substrate
11 Glass substrate
12 Lower layer electrode
13 Insulating layer
14 Upper layer electrode
14A Electrode part
14B Space
15 Alignment film
20 Substrate
21 Glass substrate
22 Alignment film
30 Liquid crystal layer
31 Liquid crystal molecule

1. A liquid crystal panel of a vertical alignment type, comprising:
a first substrate on which (i) a lower layer electrode constituted by an allover electrode and (ii) an upper layer electrode constituted by a comb electrode are provided so as to overlap each other via an insulating layer;
a second substrate which faces the first substrate;
a liquid crystal layer sandwiched between the first substrate and the second substrate; and
a first alignment film provided on the first substrate so as to be in contact with the liquid crystal layer and a second alignment film provided on the second substrate so as to be in contact with the liquid crystal layer, the first and second alignment films causing liquid crystal molecules in the liquid crystal layer to be aligned perpendicularly to the first and second substrates while no electric field is applied,
the liquid crystal layer being driven by a transverse electric field which is generated between the lower layer electrode and the upper layer electrode provided on the first substrate, and
the first and second vertical alignment films each having a polar anchoring energy falling within a range from more than 5×10⁻⁶ J/m² to not more than 1×10⁻⁴ J/m².

2. The liquid crystal panel according to claim 1, wherein the polar anchoring energy is not more than 5×10⁻⁵ J/m².

3. The liquid crystal panel according to claim 2, wherein the polar anchoring energy is not more than 1×10⁻⁵ J/m².

4. A liquid crystal display device, comprising a liquid crystal panel recited in claim 1.
